(19) United States
(12) Patent Application Publication
(10) Pub. No.: US 2022/0322887 A1
(43) Pub. Date: Oct. 13, 2022

(54) Portable Cutting Apparatus

(71) Applicant: PECOS USA, LLC, Austin, TX (US)

(72) Inventor: Frederick Gowen Scheen, Austin, TX (US)

(73) Assignee: PECOS USA, LLC, Austin, TX (US)

(21) Appl. No.: 17/224,335

(22) Filed: Apr. 7, 2021

(51) Int. Cl. A47J 47/00; B29C 41/04

(52) U.S. Cl. CPC A47J 47/005; B29C 41/04; B29K 2023/06; B29L 2031/72

(57) ABSTRACT

A portable cutting apparatus is described. The portable cutting apparatus includes a cutting board having a top surface and a bottom surface. The bottom surface includes a first sidewall positioned at a first side of the bottom surface and a second sidewall positioned at a second side of the bottom surface. The portable cutting apparatus further includes a first reinforcement plate positioned at a first end of the bottom surface and a second reinforcement plate positioned at a second end of the bottom surface. The first and second reinforcement plates are positioned orthogonal to the first and second sidewalls and are configured to provide reinforcement for an elevation system when the portable cutting apparatus is in an elevated state. The first and second reinforcement plates and the first and second sidewalls of the bottom surface form a storage cavity for storing the elevation system.

### BACKGROUND

When engaged in outdoor activities, such as camping, boating, tailgating, barbequing, fishing, or hunting, users often need to find a sturdy surface to prepare food and drinks, filet fish, process game meat, and so forth. As these types of activities occur outdoors, however, it can be difficult to find such a surface that is portable and compact so that it can be easily taken into the outdoors, and yet is also durable enough to support such activities. For example, a conventional plastic table or card table would likely bend, break, or crack if used to butcher an elk, whereas a wooden or metal table is too heavy and bulky to be easily transported for outdoor activities.

### SUMMARY

A portable cutting apparatus is described. The portable cutting apparatus includes a cutting board having a cutting surface and a bottom surface. The bottom surface of the cutting board includes side walls disposed along opposite edges of the bottom surface. The portable cutting apparatus further includes a first reinforcement plate attached to the side walls at a first end of the bottom surface and a second reinforcement plate attached to the side walls at a second end of the bottom surface. The first and second reinforcement plates are configured to provide reinforcement for an elevation system when the portable cutting apparatus is in an elevated state. The side walls and the first and second reinforcement plates form a storage cavity for storing the elevation system when the portable cutting apparatus is in a storage state.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of a portable cutting apparatus having a cutting board and reinforcement plates that form a cavity for storing an elevation system.

FIG. 2 depicts the portable cutting apparatus in various stages of deployment of the elevation system.

FIG. 3 depicts a cutaway view of the portable cutting apparatus showing a threshold mechanism to secure the elevation system in the cavity.

FIG. 4 depicts a cutting surface of the portable cutting apparatus along with a view of a portion of a bottom surface of the portable cutting apparatus.

FIG. 5 depicts a procedure in an example implementation in which a storage cavity of a portable cutting apparatus is formed by attaching reinforcement plates to a bottom surface of a cutting board.

### DETAILED DESCRIPTION

Overview

To overcome these problems, a portable cutting apparatus is described. In accordance with the described techniques, the portable cutting apparatus includes a cutting board having a cutting surface and a bottom surface. The cutting board is formed so that the bottom surface includes side walls which are disposed along opposite edges of the bottom surface of the cutting board. In one or more implementations, the cutting board may be formed using a roto-molding technique, such that the cutting board comprises roto-molded polyethylene. By using roto-molding—rather than forming the cutting board using other techniques like blow molding—the cutting board may be more durable than cutting surfaces that are formed using those other techniques. Moreover, the roto-molded polyethylene cutting board may be injected with foam, which further increases the durability of the cutting board as compared to cutting surfaces formed using those other techniques.

The portable cutting apparatus also includes an elevation system to elevate the cutting board. By elevating the cutting surface of the cutting board, the elevation system may enable users to deploy the portable cutting apparatus in a manner that is more ergonomically friendly, sanitary, and convenient, than simply placing a cutting board on various surfaces, such as on the ground, a cooler, a user's lap while seated, or a truck tailgate, to name just a few. Another advantage of the portable cutting apparatus is that it provides a standalone, dedicated cutting surface. This allows a user to position the portable cutting apparatus away from tables or other surfaces where users may cut or prepare food, and in so doing, prevent whatever the user is handling on the cutting surface from contaminating food being prepared on those other surfaces (and vice-versa).

The portable cutting apparatus also includes first and second reinforcement plates which provide reinforcement for the elevation system when the portable cutting apparatus is in an elevated state. The reinforcement plates may be attached to the side walls at opposite ends of the bottom surface of the cutting board. In one or more implementations, the elevation system may include a plurality of legs which may be inserted into sockets (e.g., screwed into the sockets) positioned on the bottom surface of the portable cutting apparatus. The reinforcement plates may include apertures (e.g., holes), through which the ends of the ends of the legs pass, when the legs are received in the sockets. An advantage of a configuration where the legs of the elevation system screw into the sockets is that the legs may be easily deployed and removed by simply screwing them in and unscrewing them, respectively.

In addition to providing reinforcement for the elevation system, the first and second reinforcement plates act in concert with the side walls to form a storage cavity for storing the elevation system (e.g., the legs) when the portable cutting apparatus is in a storage state. In other words, the elevation system may be stored in the storage cavity of the portable cutting apparatus when the elevation system is not deployed to elevate the portable cutting apparatus. Storing the elevation system within the storage cavity enables the portable cutting apparatus to be more “compact” than when the elevation system is deployed. This enables the portable cutting apparatus to be stored (e.g., in a trunk, in a truck bed, in a closet, or on a shelf) more easily than cutting apparatuses having an elevation system that remains deployed.

By storing the elevation system, the storage cavity also enables the elevation system to be stored together with the portable cutting apparatus—rather than separately from the portable cutting apparatus. This allows a user to carry or handle the portable cutting apparatus and its elevation system together. The ability to store the elevation system in the storage cavity may thus alleviate difficulties of having separate pieces, e.g., the storage may reduce how often a user needs to pick up and load his or her arms with the portable cutting apparatus and elevation system, separately, and may also reduce or eliminate the need to determine how to stuff the portable cutting apparatus and the elevation system into a separate storage container such as a bag or box.

In the following discussion, an example a portable cutting apparatus is described by way of example as comprising reinforcement plates attached to a roto-molded cutting board to form a cavity for storing an elevation system. However, it should be readily apparent that the following discussion is not limited to a cutting board. Reinforcement plates may be attached to other roto-molded objects to form cavities for storing elevation systems that can be deployed to elevate those objects without departing from the spirit or scope of the described techniques.

Portable Cutting Apparatus

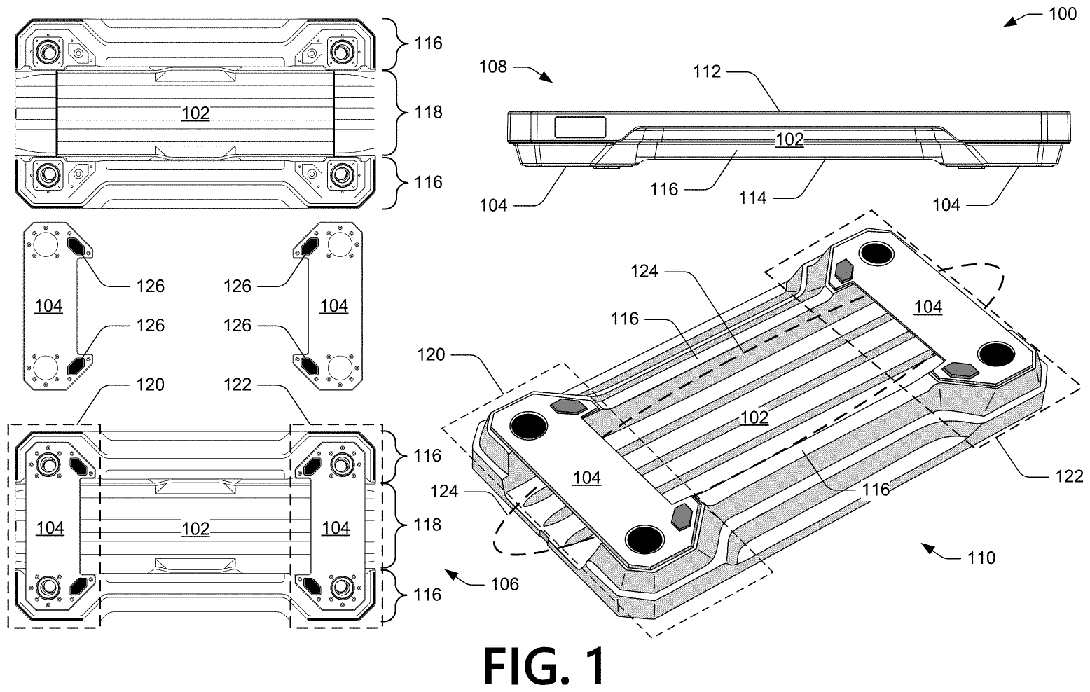

FIG. 1 is an illustration of an example 100 implementation of a portable cutting apparatus having a cutting board and reinforcement plates that form a cavity for storing an elevation system. The illustrated example 100 includes cutting board 102 and reinforcement plates 104. In this example 100, the cutting board 102 and the reinforcement plates 104 are depicted assembled as a portable cutting apparatus in views 106-108, which include bottom view 106, side view 108, and graphical projection view 110.

In accordance with the described techniques, the cutting board 102 includes cutting surface 112 and bottom surface 114. The cutting board 102 is formed so that the bottom surface 114 includes side walls 116. The side walls 116 are disposed along opposite edges of the bottom surface 114 of the cutting board 102, such that a channel 118 is formed between the side walls 116, separating the side walls 116.

In one or more implementations, the cutting board 102 may be formed using a roto-molding technique, such that the cutting board 102 comprises roto-molded polyethylene. Using a roto-molding technique, the cutting board 102 may be formed by heating plastic (e.g., polyethylene) in a mold for the cutting board 102 and by rotating the mold (e.g., bidirectionally) over a period of time. While the plastic is heated, such rotation causes the heated plastic to coat (e.g., substantially evenly) an inner surface of the mold, forming the cutting board 102 as a plastic shell. The plastic and mold are then cooled, such that the plastic shell can be removed from the mold. In one or more implementations, the shell is also filled with foam. By way of example, once the roto-molded cutting board 102 is removed from its mold, the cutting board 102 may be pressure injected with the foam, e.g., a high density polyurethane foam.

By using roto-molding—rather than forming the cutting board 102 using other techniques like blow molding—the cutting board 102 may be more durable than cutting surfaces that are formed using those other techniques. Filling a roto-molded shell, e.g., by pressure injecting foam, can also further increase the durability of the cutting board 102 relative to cutting surfaces formed using those other techniques. Additionally, by filling the cutting board 102 with a material, such as foam, the cutting board 102 has a substantially “solid” construction and not a “hollow” construction. This contrasts with various conventionally configured cutting surfaces having elevation systems. Although forming the cutting board 102 using roto-molding and injected foam is discussed, it is to be appreciated that the cutting board 102 may be formed in other ways without departing from the spirit or scope of the described techniques.

As illustrated in the bottom view 106 and the graphical projection view 110, the reinforcement plates 104 may each be attached to both of the side walls 116 in accordance with the described techniques. In particular, a first of the reinforcement plates 104 may be attached to the side walls 116 at a first end 120 of the bottom surface 114 of the cutting board 102, such that this first reinforcement plate spans from a first of the side walls 116 at the first end 120, across the channel 118 at the first end 120, and to a second of the side walls 116 at the first end 120. Further, a second of the reinforcement plates 104 may be attached to the side walls 116 at a second end 122 of the bottom surface 114 of the cutting board 102, such that this second reinforcement plate also spans from the first of the side walls 116 at the second end 122, across the channel 118 at the second end 122, and to the second of the side walls 116 at the second end 122. As depicted, the first end 120 and the second end 122 may be positioned at opposite ends of the bottom surface 114 of the cutting board 102. In one or more implementations, the side walls 116 may be substantially parallel to an axis, e.g., a longitudinal axis of the cutting board 102 or an axis that runs substantially along an edge of a rectangularly-shaped cutting board. The reinforcement plates 104 may be attached to the side walls 116 so that the reinforcement plates 104 are positioned substantially orthogonal (perpendicular) to such an axis and thus also the side walls 116. In one or more implementations, the reinforcement plates 104 are formed from a different material than the cutting board 102. For example, the reinforcement plates 104 may be metal whereas the cutting board 102 comprises a roto-molded object.

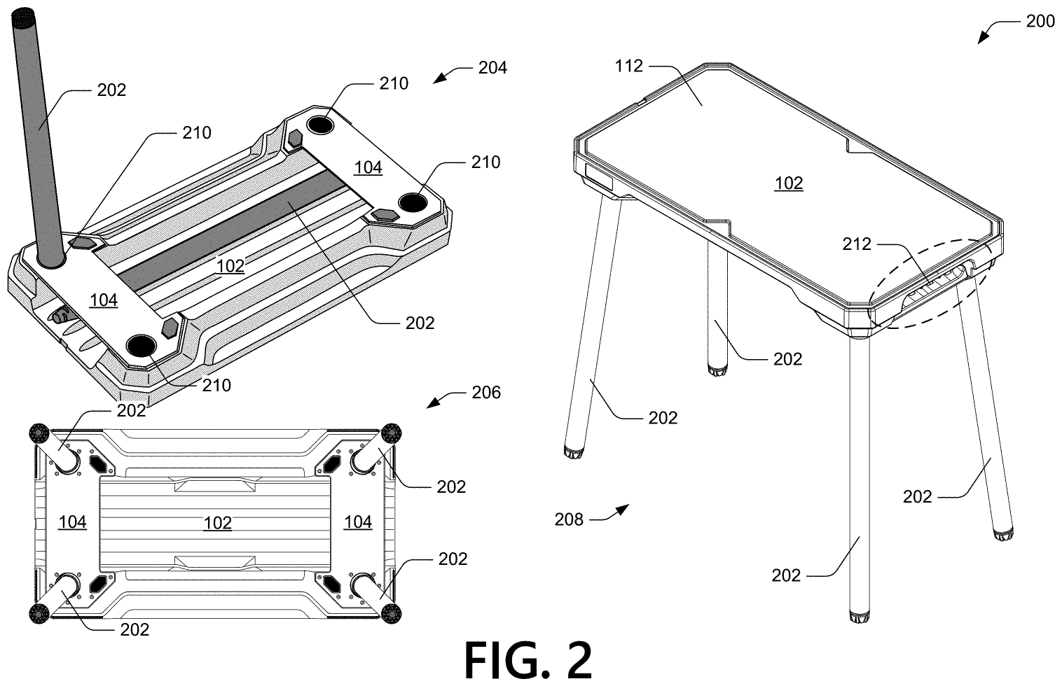

Regardless, attaching the reinforcement plates 104 to the cutting board 102 forms a storage cavity 124 of the portable cutting apparatus. Here, the storage cavity 124 is disposed between the side walls 116 (e.g., along an axis substantially parallel to a sagittal axis of the portable cutting apparatus) and between the channel 118 and the reinforcement plates 104 (e.g., along axes substantially parallel to a vertical axis of the portable cutting apparatus). The storage cavity 124 formed by attaching the reinforcement plates 104 is configured to store an elevation system (not shown) for elevating the portable cutting apparatus. For example, the elevation system may be stored in the storage cavity 124 of the portable cutting apparatus when the elevation system is not deployed to elevating the portable cutting apparatus. An example of an elevation system is discussed in more detail in relation to FIG. 2.

By storing the elevation system, the storage cavity 124 enables the portable cutting apparatus to be more “compact” than when the elevation system is deployed. This enables the portable cutting apparatus to be stored (e.g., in a trunk, in a truck bed, in a closet, or on a shelf) more easily than cutting apparatuses having an elevation system that remains deployed. By storing the elevation system, the storage cavity 124 also enables the elevation system to be stored together with the portable cutting apparatus—rather than separately from the portable cutting apparatus. This allows a user to carry or handle the portable cutting apparatus and its elevation system together. The ability to store the legs in the storage cavity 124 may thus alleviate difficulties of having separate pieces, e.g., the storage may reduce how often a user needs to pick up and load his or her arms with the portable cutting apparatus and elevation system, separately, and may also reduce or eliminate the need to determine how to stuff the portable cutting apparatus and the elevation system into a separate storage container such as a bag or box.

In the illustrated example 100, the reinforcement plates 104 are also depicted having table feet 126. The table feet 126 may be configured to elevate the cutting board 102 and the reinforcement plates 104 a first height above a surface on which the portable cutting apparatus is disposed. In accordance with the described techniques, this first height is less than a second height that the elevation system is configured to raise the cutting board 102 and the reinforcement plates 104 above the surface.

Additionally or alternatively, the table feet 126 may be configured to prevent the portable cutting apparatus from sliding across a surface, or otherwise reduce sliding, e.g., when the portable cutting apparatus is placed on the surface such that the table feet 126 physically contact the surface. The table feet 126 may be configured to prevent the portable cutting apparatus from sliding across a surface when the portable cutting apparatus is being used, e.g., when a user is cutting on the cutting surface 112 of the cutting board 102. For instance, the table feet 126 may prevent the portable cutting apparatus from sliding on a tailgate of a truck, a surface of a boat, or a kitchen counter, to name just a few. In this mode, a user may use the portable cutting apparatus with the elevation system stored, which contrasts with a mode where portable cutting apparatus is used with the elevation system deployed. In one or more implementations, for example, the table feet 126 may be formed of a material such as rubber, which may prevent the portable cutting apparatus from sliding on a variety of surfaces and at a variety of angles. It is to be appreciated that the table feet 126 may be formed from other materials without departing from the spirit or scope of the techniques described herein, and also that in one or more implementations, the portable cutting apparatus may not include the table feet 126.

Having discussed how the cutting board 102 and the reinforcement plates 104 form a cavity for storing an elevation system, consider the following example in which an elevation system and its deployment are discussed.

FIG. 2 depicts examples 200 of the portable cutting apparatus in various stages of deployment of the elevation system. In particular, the illustrated example 200 depicts deployment of elevation system 202 via various views, including a bottom projection view 204, a bottom view 206, and a top projection view 208.

In accordance with the described techniques, the elevation system 202 may comprise a plurality of legs. The bottom projection view 204 and the bottom view 206, depict insertion of the legs of the elevation system 202 into sockets 210 of the portable cutting apparatus. In one or more implementations, the sockets 210 may include leg cups disposed in the cutting board 102. The leg cups may be threaded to enable ends of the legs, having threading that corresponds to threading of the leg cups, to be received by (e.g., screwed into) the sockets 210. The reinforcement plates 104 may include apertures (e.g., holes), through which the ends of the ends of the legs pass, when the legs are received in the leg cups. In one or more implementations, the apertures may also include threading for receiving the ends of the legs. Although the leg cups are described as being separate from the reinforcement plates 104, in one or more implementations, such leg cups may be integral with the reinforcement plates 104 such that the leg cups are “dropped” into cup holes of the molded cutting board 102 when the reinforcement plates 104 are attached to the cutting board 102.

An advantage of a configuration where the legs of the elevation system 202 screw into the sockets 210 is that the legs may be easily deployed and removed by simply screwing them in and unscrewing them, respectively. Nevertheless, legs of the elevation system 202 may be deployed and removed in different ways without departing from the spirit or scope of the described techniques. Additionally or alternatively, the elevation system 202 may be configured in a different way from using legs without departing from the spirit or scope of the described techniques. By way of example, in one or more implementations the elevation system 202 may be configured with two or more elevation walls (e.g., which each attach to an opposite end of the cutting board 102). Regardless of its particular configuration, though, the elevation system 202 is nevertheless configured for storage within the storage cavity 124 formed by attaching the reinforcement plates 104 to the cutting board 102.

In the bottom projection view 204, the elevation system 202 is depicted partially deployed and partially stored. In particular, the bottom projection view 204 depicts one leg of the elevation system 202 disposed in a socket 210, e.g., “deployed”. The bottom projection view 204 also depicts one leg of the elevation system 202 disposed in the storage cavity 124, e.g., “stored” in the storage cavity 124. It is to be appreciated that in the bottom projection view 204 two of the legs are not depicted. Although the illustrated example 200 depicts an implementation where the elevation system 202 includes four legs and four sockets 210, it is to be appreciated that leg-based configurations of the elevation system 202 may have different numbers of legs without departing from the spirit or scope of the described techniques.

In the bottom view 206 and the top projection view 208, the elevation system 202 is depicted fully deployed. In connection with the illustrated example 200, the phrase “fully deployed” refers to a state where all of the legs of the elevation system 202 have been inserted into the sockets 210 and are secured, e.g., the threaded ends of the legs have been screwed into the corresponding threading of the sockets 210.

Generally speaking, the elevation system 202 is configured to elevate the cutting board 102 and the reinforcement plates 104 of the portable cutting system. The elevation system 202 may elevate the cutting board 102 and the reinforcement plates 104 a height above a surface on which the portable cutting apparatus is deployed. As noted above, this height is higher than a height that the table feet 126 are configured to elevate the cutting board 102 and the reinforcement plates 104 above a surface.

In one or more implementations, the elevation system 202 may be configured to elevate the cutting board 102 and the reinforcement plates 104 to a height that enables a user to stand while using the cutting surface 112, e.g., to prepare food or drinks, filet fish, or process game. Additionally or alternatively, the elevation system 202 may enable the cutting board 102 and the reinforcement plates 104 to be elevated to a plurality of different heights or across a range of heights, e.g., the elevation system 202 may be adjustable to different the height to which it elevates the cutting board 102 and the reinforcement plates 104. By way of example, legs of the elevation system 202 may be telescoping or otherwise extendable and retractable to different heights. In this way a height of the cutting board 102 and the reinforcement plates 104 may be adjusted for users using the apparatus having a range of different heights and/or anatomy, e.g., long or short legs. Alternatively, legs of the elevation system 202 may have a substantially static length (e.g., only endcaps of the legs may be adjustable to steady the table on an uneven surface), where the length is designed to elevate the cutting board 102 and the reinforcement plates 104 to a height that is generally suitable for a range of users.

By elevating the cutting surface 112 of the cutting board 102, the elevation system 202 may enable users to deploy the portable cutting apparatus in a manner that is more ergonomically friendly, sanitary, and convenient, than simply placing a cutting board on various surfaces, such as on the ground, a cooler, a user's lap while seated, or a truck tailgate, to name just a few. Another advantage of the portable cutting apparatus is that it provides a standalone, dedicated cutting surface. This allows a user to position the portable cutting apparatus away from tables or other surfaces where users may cut or prepare food, and in so doing, prevent whatever the user is handling on the cutting surface 112 from contaminating food being prepared on those other surfaces (and vice-versa).

In one or more implementations, the reinforcement plates 104 provide reinforcement for the elevation system 202 when the elevation system 202 elevates the portable cutting apparatus into the elevated state. By way of example, the reinforcement plates 104 may be formed from a material such as metal. Due to being constructed from metal, the reinforcement plates 104 may structurally reinforce (by bracing the side walls 116 across the channel 118) the portable cutting apparatus. The reinforcement plates 104 may also provide a more secure fit of the elevation system 202 (e.g., its legs) into receptacles of the portable cutting apparatus (e.g., the sockets 210) than the receptacles may provide without the reinforcement plates 104.

In the illustrated example 200, the top projection view 208 shows a portion of a threshold mechanism 212 configured to secure the elevation system 202 when stored in the storage cavity 124. In the context of securing the elevation system 202 in the storage cavity 124, consider the following discussion.

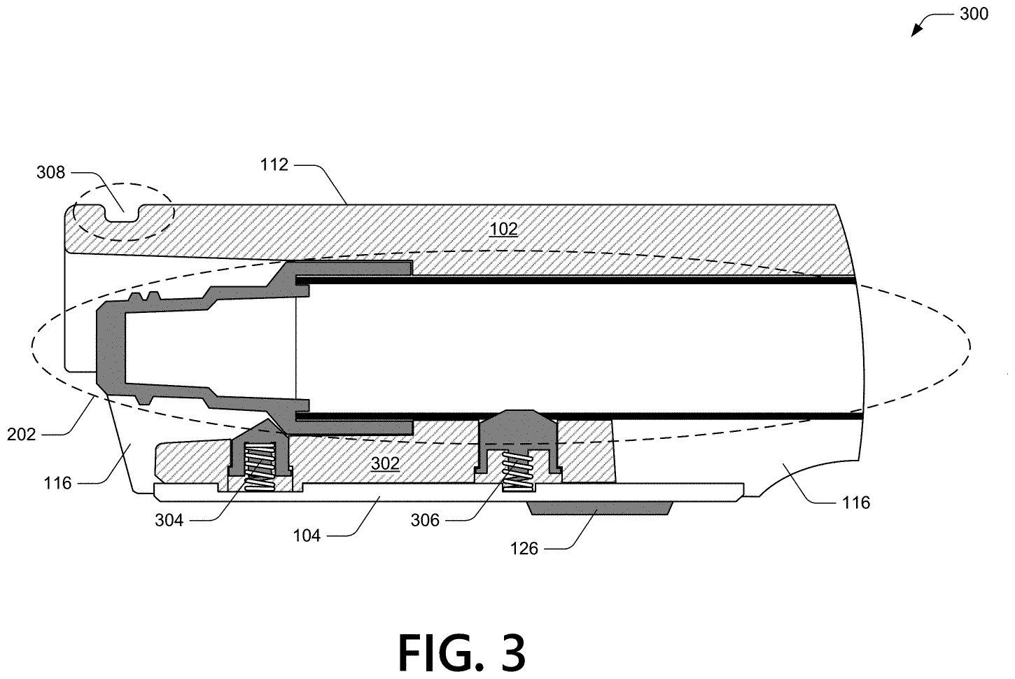

FIG. 3 depicts an example 300 of a cutaway view of the portable cutting apparatus showing a threshold mechanism to secure the elevation system in the cavity.

In the illustrated example 300, the cutaway view depicts the cutting board 102, the reinforcement plates 104, the table feet 126, and the elevation system 202 (e.g., a leg). The illustrated example 300 also includes threshold bridge 302, which is depicted having a latch 304 and a bumper 306. In this example 300, the threshold bridge 302, the latch 304, and the bottom projection view 204 form the threshold mechanism.

In general, the threshold mechanism is configured to removably secure the elevation system 202 within the storage cavity 124, formed by attaching the reinforcement plates 104 to the cutting board 102. In the scenario where the elevation system 202 includes legs, for example, the threshold mechanism is configured to mechanically secure the legs within the storage cavity 124 so that the legs cannot be easily removed without a targeted (e.g., intentional) application of force to remove the legs from the storage cavity 124. In other words, the threshold mechanism is configured to mechanically secure the elevation system 202 so that it does not “fall out” of the storage cavity 124 while the portable cutting apparatus is simply being carried or otherwise moved. Nonetheless, the threshold mechanism is also configured to allow the elevation system 202 to be removed from the storage cavity 124 with a targeted application of force, such as an application of force by a user to pull the elevation system 202 out of the cavity through the threshold mechanism, where the application of force has a magnitude and a direction sufficient to overcome one or more securing components of the threshold mechanism.

In this example 300, the latch 304 and the bumper 306 may be configured as the securing components of the threshold mechanism. As illustrated, the latch 304 and the bumper 306 may be configured to secure the elevation system 202 using springs. Springs of the latch 304 and the bumper 306 may have a stiffness that causes those springs to have a resting position which disposes the latch 304 and the bumper 306 in positions to secure the elevation system 202, e.g., by pressing the elevation system 202 against a surface of the channel 118 within the storage cavity 124. The stiffness of those springs may also be selected so that the springs compress responsive to a targeted force to remove the elevation system 202 from the storage cavity 124. Responsive to such a targeted force, for example, the springs of the latch 304 and the bumper 306 may be configured to compress, allowing the elevation system 202 to pass over the latch 304 and the bumper 306. The springs of the latch 304 and the bumper 306 may also be configured to compress when the elevation system 202 passes over the latch 304 and the bumper 306 during insertion into the storage cavity 124. When those springs are compressed, they store mechanical energy. When there is space for the springs to advance the latch 304 and the bumper 306 away from the reinforcement plates 104, though, the mechanical energy stored in the springs causes the springs to decompress (e.g., spring) back toward their resting positions.

To this end, the elevation system 202 may have a shape configured to enable securing components, such as the latch 304, to actuate to a position that secures the elevation system 202, responsive to the elevation system 202 being disposed substantially in a storage position. As discussed in more detail below, the portable cutting apparatus may be configured with a threshold bridge 302 at each end, e.g., a first threshold bridge 302 at the first end 120 and a second threshold bridge 302 at the second end 122. In such a configuration, the pair of threshold bridges may be configured identically or substantially identically, e.g., both threshold bridges may include a similar or same set of the latches 304 and the bumpers 306—each threshold bridge may include a latch and a bumper for each leg. In this way, the bumpers 306 may be configured to press against the legs at both ends, e.g., a bumper of one threshold bridge may press against a leg proximate the end of the leg (the portion inserted into the leg cups) and a bumper of the other threshold bridge may press against that leg proximate a foot of the leg (the portion contacting the ground when in the elevated state). In this way, the bumpers 306 may prevent one or more portions of the elevation system 202 from “rattling around” in the storage cavity 124.

Additionally, an end of each leg of the elevation system 202 may have a shape that is configured to contact a portion of the threshold bridge 302 (e.g., a wall or lip of the bridge's surface) and the latch 304 when the leg is inserted into the storage cavity 124 and reaches the storage position. In the storage position, the end of the leg may be shaped so that a portion of the shape is secured between the latch 304 in the non-compressed position and the portion of the threshold bridge 302 (e.g., the wall or lip). The threshold bridge 302 may include various combinations of securing components, such as combinations having at least one latch and/or at least one bumper.

In one or more implementations, the threshold bridge 302 is attached to one of the reinforcement plates 104, such that each reinforcement plate has a respective threshold bridge 302. In such implementations, the legs can be inserted into the storage cavity 124 via either end of the portable cutting apparatus, e.g., there may be threshold mechanisms 212 at one or both ends 120, 122 of the portable cutting apparatus. The reinforcement plates 104 and their respective threshold bridge 302 may be attached to form a threshold assembly. In this way, when the reinforcement plates 104 are attached to the cutting board 102, the threshold bridges 302 are also attached as part of the portable cutting apparatus. By way of example, the threshold bridge 302 may be inserted between the side walls 116 of the cutting board 102, such that the threshold bridge 302 contacts the side walls 116. Thus, when the threshold assembly is attached to the cutting board 102 for operation, the threshold bridge 302 may contact the side walls 116 along the channel 118, and the respective reinforcement plate 104 may contact the side walls 116 along a surface of the cutting board 102 that faces a surface on which the portable cutting apparatus is deployed.

Although the threshold mechanism is discussed as comprising a threshold bridge 302 with a plurality of the latches 304 and the bumpers 306 to mechanically secure the elevation system 202 (e.g., legs) while stored in the storage cavity 124 (e.g., based on springs), it is to be appreciated that the threshold mechanism may be configured in different ways to secure the elevation system 202 within the storage cavity 124 in the spirit or scope of the described techniques.

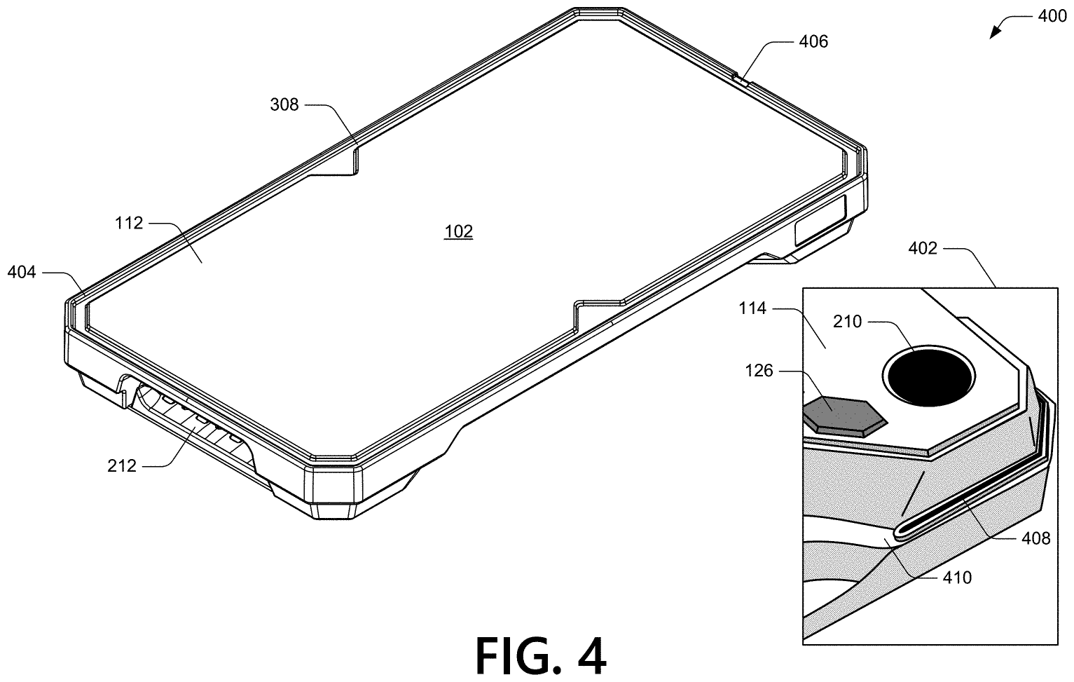

In the illustrated example 300, the cutting board 102 also is depicted having drip channel 308. In general, the drip channel 308 is configured to hold liquids (e.g., blood) that flow from the cutting surface 112. By holding those liquids, the drip channel 308 may reduce an amount of liquid on the cutting surface 112 while a user is cutting. This may enable safer and easier cutting on the cutting surface 112 of the portable cutting apparatus. Consider the following discussion of FIG. 4, which describes one example of the drip channel 308.

FIG. 4 depicts an example 400 of a cutting surface of the portable cutting apparatus along with a view of a portion of a bottom surface of the portable cutting apparatus.

The illustrated example 400 includes the cutting board 102 from FIG. 1. In particular, the illustrated example 400 depicts a view of the cutting surface 112 of the cutting board 102 along with a separate view 402 of a portion of the bottom surface 114 of the cutting board 102. In this example 400, the drip channel 308 is depicted bordering the cutting surface 112 and is further surrounded by lip 404, which enables liquids to be captured and held in the drip channel 308 and routed to a spillway 406 rather than simply spill over any edge of the portable cutting apparatus.

In one or more implementations, the portable cutting apparatus also includes one or more accessory attachment mechanisms 408. In the illustrated example, the accessory attachment mechanism 408 is depicted as a protrusion, e.g., protruding from the bottom surface 114 of the cutting board 102. It is to be appreciated, however, that in one or more implementations, the accessory attachment mechanisms 408 may be configured as cavities rather than protrusions. Indeed, the accessory attachment mechanisms 408 may be configured in a variety of ways to enable accessories to be clipped to the portable cutting apparatus.

By way of example, the accessory attachment mechanisms 408 may be positioned substantially at corners of the bottom surface 114 of the cutting board 102, e.g., one mechanism at each corner. For instance, the accessory attachment mechanisms 408 may be positioned on or within shelves 410 at the corners of the bottom surface 114, e.g., protrusions may be attached to the shelves 410 or cavities may be formed into those shelves 410. Accessories may thus be removably attached to corners of the portable cutting apparatus. It is to be appreciated that the portable cutting apparatus may include accessory attachment mechanisms 408 at different locations, e.g., along the ends 120, 122, of the bottom surface 114 without departing from the spirit or scope of the techniques described herein.

In general, the accessory attachment mechanisms 408, in concert with the drip channel 308 and the lip 404, may enable accessories to be “clipped” onto the cutting board 102. By way of example, an accessory may include a first channel having a complementary shape to the lip 404 and a second channel or a protrusion having a complementary shape to the accessory attachment mechanisms 408. When the accessory attachment mechanisms 408 are configured as protrusions, an accessory configured with first and second channels may be clipped onto the cutting board 102 such that the lip 404 is disposed in the first channel of the accessory and an accessory attachment mechanism 408 is disposed in the second channel of the accessory. When the accessory attachment mechanisms 408 are configured as cavities, an accessory configured with a channel complementary to the lip 404 and a protrusion complementary to the mechanism may be clipped onto the cutting board 102 such that the lip 404 is disposed into the accessory's channel and such that the accessory's protrusion is disposed within the accessory attachment mechanism 408. Examples of accessories may include, but are not limited to, beverage holders, knife or other utensil holders, tool holders, surface extensions, and lighting, to name just a few. It is to be appreciated that accessories may be clipped around edges of the cutting board 102 in different ways in the spirit or scope of the techniques described herein.

In one or more implementations, the cutting surface 112 with the drip channel 308 may be configured to interface with one or more additional cutting surfaces. By way of example, an additional cutting surface having a depth and a width substantially similar to the cutting surface may be disposed “on top” of the cutting surface 112. For instance, a user may place an aesthetically pleasing (e.g., acacia, teak, or bamboo) additional cutting surface on top of the cutting surface 112. Such an additional cutting surface may include protrusions having a complementary shape to the drip channel 308, such that when the additional cutting surface is placed on top of the cutting surface 112, those protrusions are disposed in the drip channel 308. As mentioned above, the cutting surface 112 may be configured to have two additional cutting surfaces placed on top, such that the two additional cutting surfaces are placed side-by-side. Each of those additional cutting surfaces may have protrusions that match a respective half of the drip channel 308, such that when one those additional cutting surfaces is placed on the cutting surface 112 its protrusions are disposed within a respective half of the drip channel 308. It is to be appreciated that the portable cutting apparatus may be configured in different ways for the removable attachment of accessories without departing from the spirit or scope of the described techniques.

Having discussed exemplary details of the portable cutting apparatus, consider now some examples of procedures to illustrate additional aspects for deployment of the apparatus.

### Example Procedures

This section describes examples of procedures for the portable cutting apparatus. The procedures are shown as a set of blocks that specify operations performed and are not necessarily limited to the orders shown for performing the operations by the respective blocks.

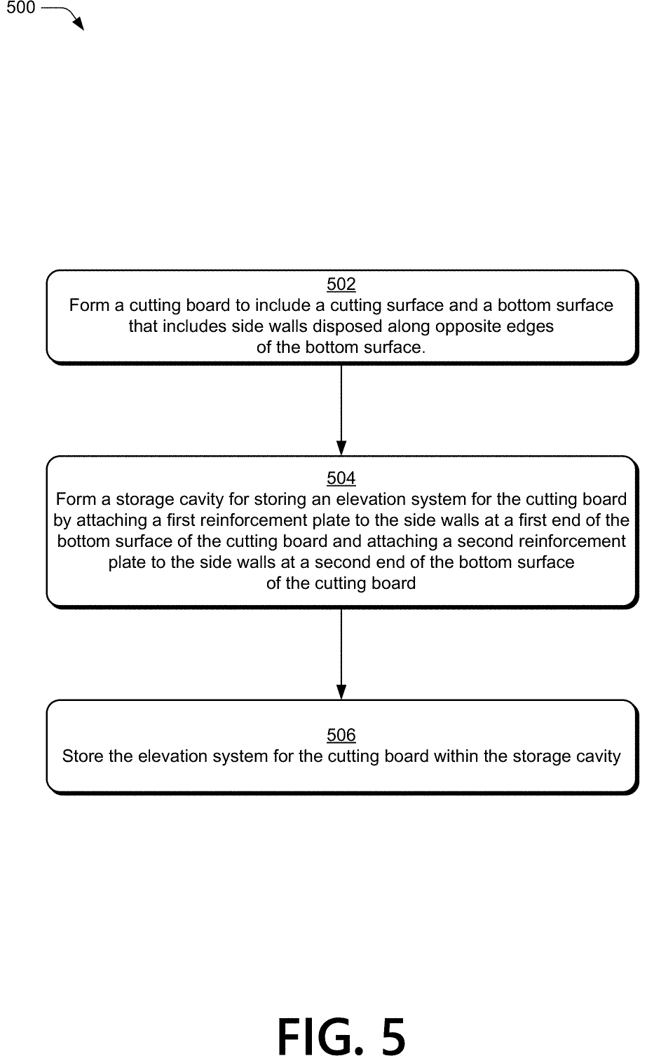

FIG. 5 depicts a procedure 500 in an example implementation in which a storage cavity of a portable cutting apparatus is formed by attaching reinforcement plates to a bottom surface of a cutting board.

A cutting board is formed to include a cutting surface and a bottom surface that includes side walls disposed along opposite edges of the bottom surface (block 502). By way of example, cutting board 102 is formed to include cutting surface 112 and bottom surface 114. The cutting board 102 is formed so that the bottom surface 114 includes side walls 116. The side walls 116 are disposed along opposite edges of the bottom surface 114 of the cutting board 102, such that a channel 118 is formed between the side walls 116, separating the side walls 116.

In one or more implementations, the cutting board 102 may be formed using a roto-molding technique, such that the cutting board 102 comprises roto-molded polyethylene. By using roto-molding—rather than forming the cutting board 102 using other techniques like blow molding—the cutting board 102 may be more durable than cutting surfaces that are formed using those other techniques. Filling a roto-molded shell, e.g., by pressure injecting foam, can also further increase the durability of the cutting board 102 relative to cutting surfaces formed using those other techniques. Additionally, by filling the cutting board 102 with a material, such as foam, the cutting board 102 has a substantially “solid” construction and not a “hollow” construction. This contrasts with various conventionally configured cutting surfaces having elevation systems.

A storage cavity is formed for storing an elevation system for the cutting board by attaching a first reinforcement plate to the side walls at a first end of the bottom surface of the cutting board and attaching a second reinforcement plate to the side walls at a second end of the bottom surface of the cutting board (block 504). By way of example, the reinforcement plates 104 may each be attached to both of the side walls 116 in order to form the storage cavity 124 for storing the elevation system 202. A first of the reinforcement plates 104 may be attached to the side walls 116 at a first end 120 of the bottom surface 114 of the cutting board 102, such that this first reinforcement plate spans from a first of the side walls 116 at the first end 120, across the channel 118 at the first end 120, and to a second of the side walls 116 at the first end 120. Further, a second of the reinforcement plates 104 may be attached to the side walls 116 at a second end 122 of the bottom surface 114 of the cutting board 102, such that this second reinforcement plate also spans from the first of the side walls 116 at the second end 122, across the channel 118 at the second end 122, and to the second of the side walls 116 at the second end 122. As depicted, the first end 120 and the second end 122 may be positioned at opposite ends of the bottom surface 114 of the cutting board 102. In one or more implementations, the side walls 116 may be substantially parallel to an axis, e.g., a longitudinal axis of the cutting board 102 or an axis that runs substantially along an edge of a rectangularly-shaped cutting board. The reinforcement plates 104 may be attached to the side walls 116 so that the reinforcement plates 104 are positioned substantially orthogonal (perpendicular) to such an axis and thus also the side walls 116.

The elevation system for the cutting board is stored within the storage cavity (block 506). By way of example, the elevation system 202 is stored within the storage cavity 124. In one or more implementations, the elevation system 202 may comprise a plurality of legs, each of which may be stored within the storage cavity 124.

### CONCLUSION

Although aspects of a portable cutting apparatus have been described in language specific to structural features and/or methods, it is to be understood that the appended claims are not necessarily limited to the specific features or methods described. Rather, the specific features and methods are disclosed as example implementations of a portable cutting apparatus. Further, various different examples are described, and it is to be appreciated that each described example can be implemented independently or in connection with one or more other described examples.

What is claimed is:

1. A portable cutting apparatus comprising:
a cutting board comprising a cutting surface and a bottom surface, the bottom surface comprising side walls disposed along opposite edges of the bottom surface; and
a first reinforcement plate attached to the side walls at a first end of the bottom surface of the cutting board and a second reinforcement plate attached to the side walls at a second end of the bottom surface of the cutting board, the first and second reinforcement plates configured to provide reinforcement for an elevation system when the portable cutting apparatus is in an elevated state, the side walls and the first and second reinforcement plates forming a storage cavity for storing the elevation system when the portable cutting apparatus is in a storage state.

2. The portable cutting apparatus as described in claim 1, further comprising a threshold mechanism to removably secure the elevation system within the storage cavity.

3. The portable cutting apparatus as described in claim 2, wherein the elevation system comprises a plurality of legs.

4. The portable cutting apparatus as described in claim 3, wherein the threshold mechanism comprises at least one latch to secure the plurality of legs within the storage cavity.

5. The portable cutting apparatus as described in claim 3, wherein the cutting board further includes a plurality of sockets, each socket of the plurality of sockets configured to receive a leg of the plurality of legs of the elevation system to elevate the portable cutting apparatus in the elevated state.

6. The portable cutting apparatus as described in claim 1, wherein the elevation system is adjustable to elevate the portable cutting apparatus to a plurality of different heights.

7. The portable cutting apparatus of claim 1, wherein the cutting surface of the cutting board comprises a drip channel that borders the cutting surface to capture liquids and route the liquids to a spillway.

8. The portable cutting apparatus of claim 7, wherein the drip channel enables accessories to be clipped onto the cutting board.

9. The portable cutting apparatus of claim 1, wherein the side walls are substantially parallel to a longitudinal axis of the cutting board, and wherein the first and second reinforcement plates are positioned substantially orthogonal to the side walls.

10. The portable cutting apparatus of claim 1, wherein the cutting board is formed from polyethylene using a roto-molding technique.

11. The portable cutting apparatus of claim 10, wherein the first and second reinforcement plates are metal in order to structurally reinforce the elevation system when the portable cutting apparatus is in the elevated state.

12. A method comprising:
forming a cutting board to include a cutting surface and a bottom surface that includes side walls disposed along opposite edges of the bottom surface;
forming a storage cavity for storing an elevation system for the cutting board by attaching a first reinforcement plate to the side walls at a first end of the bottom surface of the cutting board and attaching a second reinforcement plate to the side walls at a second end of the bottom surface of the cutting board; and
storing the elevation system for the cutting board within the storage cavity.

13. The method as described in claim 12, wherein the first reinforcement plate and the second reinforcement plate provide reinforcement for the elevation system when the cutting board is in an elevated state.

14. The method as described in claim 12, wherein the elevation system comprises a plurality of legs.

15. The method as described in claim 14, wherein the storing comprises storing the plurality of legs within the storage cavity.

16. The method as described in claim 14, further comprising elevating the cutting board by attaching the plurality of legs to a plurality of sockets in the bottom surface of the cutting board.

17. A system comprising:
a cutting board comprising a cutting surface and a bottom surface;
a plurality of legs removably attached to the bottom surface to elevate the cutting board; and
a storage cavity positioned on the bottom surface of the cutting board, the storage cavity configured to store the legs.

18. The system as described in claim 17, further comprising a threshold mechanism to removably secure the plurality of legs within the storage cavity.

19. The system as described in claim 18, wherein the threshold mechanism comprises at least one latch to secure the plurality of legs within the storage cavity.

20. The system as described in claim 18, wherein the threshold mechanism secures the plurality of legs within the storage cavity using one or more springs.
